(19) United States
(12) Patent Application Publication
(10) Pub. No.: US 2023/0116369 A1
(43) Pub. Date: Apr. 13, 2023

(54) LITHIUM MIXED INORGANIC ELECTROLYTES

(71) Applicants: SAFT, LEVALLOIS PERRET (FR); Centre national de la recherche scientifique, PARIS (FR); ECOLE NATIONALE SUPERIEURE D INGENIEURS DE CAEN, CAEN CEDEX 4 (FR); UNIVERSITE DE CAEN NORMANDIE, CAEN CEDEX (FR)

(72) Inventors: Vincent PELE, BORDEAUX (FR); Nadège ROUMEGOUS, AMBARES ET LAGRAVE (FR); Christian JORDY, ST LOUIS DE MONTFERRAND (FR); Valérie PRALONG, CAEN (FR)

(73) Assignees: SAFT, LEVALLOIS PERRET (FR); Centre national de la recherche scientifique, PARIS (FR); ECOLE NATIONALE SUPERIEURE D INGENIEURS DE CAEN, CAEN CEDEX 4 (FR); UNIVERSITE DE CAEN NORMANDIE, CAEN CEDEX (FR)

(21) Appl. No.: 17/914,394

(22) PCT Filed: Mar. 23, 2021
(86) PCT No.: PCT/EP2021/057459

§ 371 Date: Sep. 26, 2022

(30) Foreign Application Priority Data
Mar. 26, 2020 (FR) FR20 02987

(51) Int. Cl. C01B 17/22; C01B 25/14; H01M 10/0562

(52) U.S. Cl. CPC C01B 17/22; C01B 25/14; H01M 10/0562; H01M 2300/008

(57) ABSTRACT

The present application relates to novel mixed compounds based on oxides and sulfides, and the use thereof as a solid electrolyte, with improved sulfide stability. The application further relates to electrochemical elements and lithium batteries containing such electrolytes.

### CROSS REFERENCE TO RELATED APPLICATIONS

The present application is a U.S. National Phase Application under 35 U.S.C. § 371 of International Patent Application No. PCT/EP2021/057459 filed Mar. 23, 2021, which claims priority of French Patent Application No. 20 02987 filed Mar. 26, 2020. The entire contents of which are hereby incorporated by reference.

### FIELD OF THE INVENTION

The present invention relates to the field of batteries, and in particular to batteries with solid electrolyte, such as sulfides.

### BACKGROUND

The solid sulfide electrolytes have reached sufficient maturity for the industrial use thereof to be envisaged. The high ionic conductivity values thereof combined with the ductility thereof and the limited density thereof make same serious candidates for the first generations of all-solid batteries which can compete with the energy densities of current Li-ion batteries with liquid electrolytes.

However, such advantages are counterbalanced by the low stability of sulfides. In the presence of moisture, sulfides are likely to react and spontaneously release a toxic gas, H₂S. In addition, sulfides have limited windows of potential stability and can thus degrade when in contact with the active electrode materials with which same are associated in cells. Since such active materials are often oxides (mainly in the positive electrode), another phenomenon related to space charges can be a source of additional charging.

Hence the stability of electrolytes thus remains to be improved, while maintaining a satisfactory conductivity and energy densities, in order to accelerate the progress of all-solid technologies so that the industrialization thereof can be envisaged with limited safety risks.

Oxides, on the other hand, are generally more stable (electrochemically and chemically) but have lower ionic conductivities and require heat treatments at high temperature (>700° C.), which are not suitable for an industrial application. Moreover, the higher density thereof and the poor ductility thereof limit the energy densities which can be obtained during the use thereof.

Novel mixed inorganic compounds have now been discovered which have, in particular, improved stability compared to sulfide electrolytes, while maintaining the electrochemical performance thereof, in particular without degrading the ionic conductivity.

### SUMMARY

According to a first subject matter, the present invention relates to a composition with formula (I):

((A₍ₜ₋ᵥ₎B_{v/2})[(PS₄)₍₁₋ₓ₎(OH_{z}A_{U}X₁)ₓ])_{(1-y)}(LiₙX₂)_{y} (I)

Wherein:

A=Li,Na,K;

B=Mg,Ca;

X₁=F,Cl,Br,I;

X₂=N,O,S,F,Cl,Br,I,BH₄,CᵢBⱼHⱼ₊₁;

n is such that:

n=3 for X₂=N, or

n=2 for X₂=0,S, or

n=1 for X₂=F,Cl,Br,I,BH₄,CᵢBⱼHⱼ₊₁;
where i and j are integers and i=1 or 2 and 8≤j≤11;

0<y<0.40,

0<x<0.7,

0<z<1;

u is either positive, negative or zero, and such that u+z=0;

0≤v≤0.3;

2.8≤t≤3.5;

Where it is understood that X₂≠X₁

In the compounds with formula (I) according to the invention, the presence of oxide makes it possible to increase the stability of sulfide electrolytes, to reduce the risks associated with the use thereof while maintaining their electrochemical performance: The compounds with formula (I) are used for the conduction of alkaline ions (in particular lithium).

Due to the mixed oxide and sulfide composition thereof, same combine the advantages of the different families of inorganic electrolytes while limiting the disadvantages thereof, in particular with regard to the low stability of sulfides.

The compounds with formula (I) thus make it possible to simplify the use of inorganic sulfide-based electrolytes and to accelerate the progress of all-solid technologies due to industrialization with limited safety risks.

The following embodiments can be mentioned, each of the embodiments being taken individually or according to each of the possible combinations thereof:

A=Li and X₁=Cl; and/or

t=3,u=0,y=0 and z=0.

In particular, according to one embodiment, the compound with formula (I) is represented by formula (I′):

Li₃(PS₄)₁₋ₓ(OCl)ₓ (I′)

x being defined as above.

According to one embodiment, x is preferentially between 0.02 and 0.20.

Indeed, and without wishing to be bound by theory, the inventors have demonstrated a synergistic effect for the mixed electrolytes according to the invention for values of x less than 0.2: for such values, the electrolyte causes a lower release of H₂S than the release from mixed electrolyte with a higher amount of Li₃OCl (x greater than 0.2), whereas a lower release could be expected due to a lower amount of sulfides in the mixture.

As compounds corresponding to formula (I) according to the invention, the following representative compounds can be mentioned:

Li₃(PS₄)_{0.884}(OCl)_{0.116}

Li₃(PS₄)_{0.793}(OCl)_{0.207}

Li₃[(PS₄)_{0.85}(OCl)_{0.15}])_{0.80}(LiBr)_{0.20}

Li_{3.2}[(PS₄)_{0.90}(OCl)_{0.10}])_{0.70}(Lil)_{0.30}

(Li_{2.8}Mg_{0.1})[(PS₄)_{0.90}(OCl)_{0.10}]

(Li₃[(PS₄)_{0.85}(OCl)_{0.15}])_{0.95}(Li₃N)_{0.05}

Li₃[(PS₄)_{0.85}(OBr)_{0.15}])_{0.90}(Lil)_{0.10}

(Li_{2.98}[(PS₄)_{0.80}(OH)_{0.02}Br_{0.20}])_{0.90}(Lil)_{0.10}

According to another subject matter, the present application further relates to the preparation method of compounds with formula (I) according to the invention, said method comprising the step of co-grinding the precursors of the compound with formula (I). In particular, said precursors may be chosen from compounds with formula:

A₂O,BO,A₂S,LiX₁,LiX₂,P₂S₅,AOH

Wherein A, B, X₁ are defined as in formula (I).

Generally, the co-grinding step is carried out by mixing said precursors in the desired proportions, typically in proportions observing the molar ratios required by formula (I).

According to one embodiment, the co-grinding can be carried out at ambient temperature.

According to one embodiment, the co-grinding can be carried out using a ball mill.

Typically, the co-grinding can be carried out by a mill marketed by Fritsch (Fritsch 7), with balls with a diameter comprised between 0.1 and 15 mm, in 10 to 50 ml bowls, during cycles lasting between 1 minute and 2 hours for a total duration comprised between 5 and 100 h, at a rotational speed comprised between 100 and 1000 rpm. Typically, the particle size of the mixture after co-grinding is less than 10 μm, in particular less than 1 μm.

The precursors A₂0, BO, A₂S, LiX₁, LiX₂, P₂S₅, AOH are commercially available, e.g., such materials are available from Aldrich or Alfa Aesar.

Typically, the precursors are in crystalline form.

According to one embodiment, the compounds with formula (I) obtained by the process according to the invention, have an amorphous structure.

According to one embodiment, in the case of compound (I′), the preparation method for compound (I′) comprises the step of co-grinding the precursors Li₂O, LiCl, Li₂S and P₂S₅.

Advantageously, some of the precursors can be in the form of a mixture beforehand. Thus, e.g. the co-grinding can be carried out by mixing a composition (II) comprising Li₂O and LiCl and a composition (III) comprising Li₂S and P₂S₅, in the ratio Li₂S/P₂S₅=3.

The compositions (II) and (III) are mixed for co-grinding in the proportions:
x part by weight of the composition (II):

Li₂O+LiCl (II)
and
(1-x) part by weight of composition (III):

3 Ll₂S+P₂S₅ (III)

Advantageously, the synthesis process according to the invention does not comprise high temperature annealing, unlike for most oxides. It is therefore favorable for large-scale production of such materials.

According to another subject matter, the present invention further relates to an electrolyte for a battery comprising a compound with formula (I) according to the invention.

According to one embodiment, said electrolyte is a solid.

According to one embodiment, said electrolyte is suitable for “all solid” batteries.

Thus, according to another subject matter, the present invention further relates to an electrochemical element comprising an electrolyte according to the invention.

The electrochemical cell according to the invention is particularly suitable for lithium batteries, such as Li-ion, Li primary (non-rechargeable) and Li-S batteries and the equivalents thereof with other alkaline elements (Na-ion, K-ion, etc.) for the corresponding formulations.

According to another subject matter, the present invention further relates to an electrochemical module comprising a stack of at least two elements according to the invention, each element being electrically connected with one or a plurality of other elements.

The term “module” refers herein to the assembly of a plurality electrochemical elements.

According to another subject matter, the present invention further relates to a battery comprising one or a plurality of modules according to the invention.

The term “battery” or “accumulator” refers herein to the assembly of a plurality of modules, where said assemblies can be in series and/or parallel. The invention preferentially relates to batteries of which capacity is greater than 100 mAh, typically 1 to 100Ah.

### BRIEF DESCRIPTION OF THE DRAWINGS

FIG. 1 shows the X-ray diffraction spectra of Li₃(PS₄)₁₋ₓ(OCl)ₓ compounds as a function of x during a 29-hour ball mill grinding; the wavelength used is that of the K lineα of copper (1.5406 angstrom).

FIG. 2 shows the X-ray diffraction spectrum of the compound Li₃(PS₄)_{0.884}(OCl)_{0.116} as a function of time for samples ground by a ball mill; the wavelength used is that of the K lineα of copper (1.5406 angstrom).

FIG. 3 shows the comparison between the H₂S release for a sample of sulfide electrolyte alone (amorphous LPS) and Li₃(PS₄)₁₋ₓ(OCl)ₓ compounds.

### DETAILED DESCRIPTION

### Examples

The following examples illustrate in a representative and non-limiting manner, an embodiment according to the invention.

### Example 1: Preparation of a composite in the Li—P—S—O—Cl system, from Li2S-P2S5-Li₂O—LiCl

Selected compositions:
X=0.714 corresponding to a 50% mass % of Li₃OCl
X=0.384 corresponding to a 20% mass % of Li₃OCl
X=0.207 corresponding to a 9.5% mass % of Li₃OCl
X=0.116 corresponding to a 5% mass % of Li₃OCl

The Li₃(PS₄)₁₋ₓ(OCl)ₓ compounds were prepared from the precursors Li₂O, LiCl, Li₂S and P₂S₅. Precursor masses are calculated for obtaining the desired stoichiometry.

TABLE 1

| The value of x in | | | | |
|---|---|---|---|---|
| the formula | | | | |
| Li₃(PS₄)₁₋ₓ(OCl)_{x.} | Li₂S | P₂S₅ | LiCl | Li₂O |
| 0.116 | 0.7273 g | 1.1731 g | 0.05866 g | 0.0413 g |
| 0.207 | 0.7283 g | 1.1727 g | 0.1173 g | 0.0827 g |
| 0.384 | 0.3062 g | 0.4938 g | 0.1173 g | 0.0827 g |
| 0.714 | 0.3828 g | 0.6172 g | 0.5865 g | 0.4134 g |

Table 1 shows the masses of the different precursors for producing

Li₃(PS₄)₁₋ₓ(OCl)ₓ compounds for the different values of x

The mixtures are carried out by ball milling (Fritsch 7) in 25 ml ZrO₂ bowls with 4 balls with a diameter of 10 mm. The bowls are rotated at 500 rpm for several 30-minute cycles. The powder inside the bowls is detached from the walls every 5 hours so as to homogenize the sample.

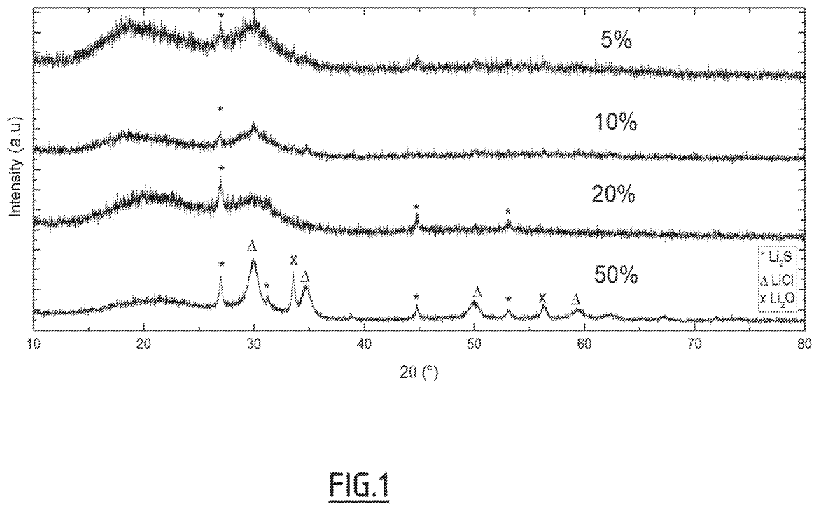

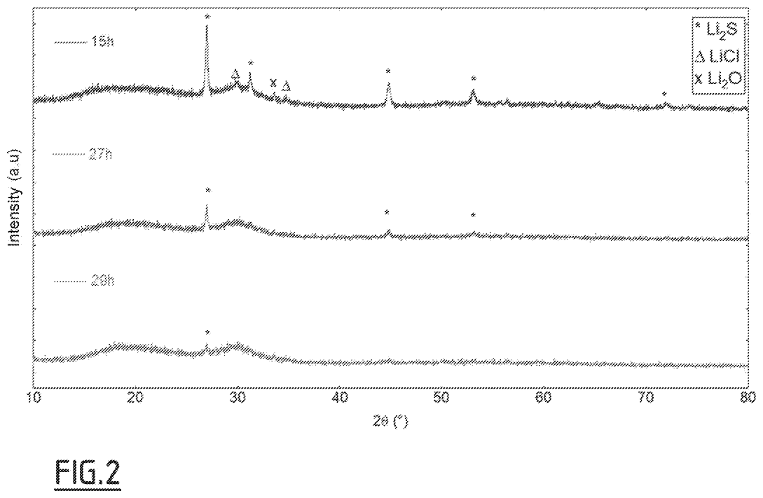

The evolution of the X-ray diffraction graph (DRX) of the compound Li₃(PS₄)_{0.884}(OCl)_{0.116} as a function of the grinding time is shown in FIG. 2. The three precursors Li₂S, LiCl and Li₂O disappear after 29 h of grinding. It is possible that the precursors have been nanostructured until forming an amorphous compound as is the case for amorphous Li₃PS₄, the amorphous structure being characterized by a lack of medium and long distance order resulting in very wide diffraction lines. The grinding time will thus be taken as a reference for the other mixtures (FIG. 1).

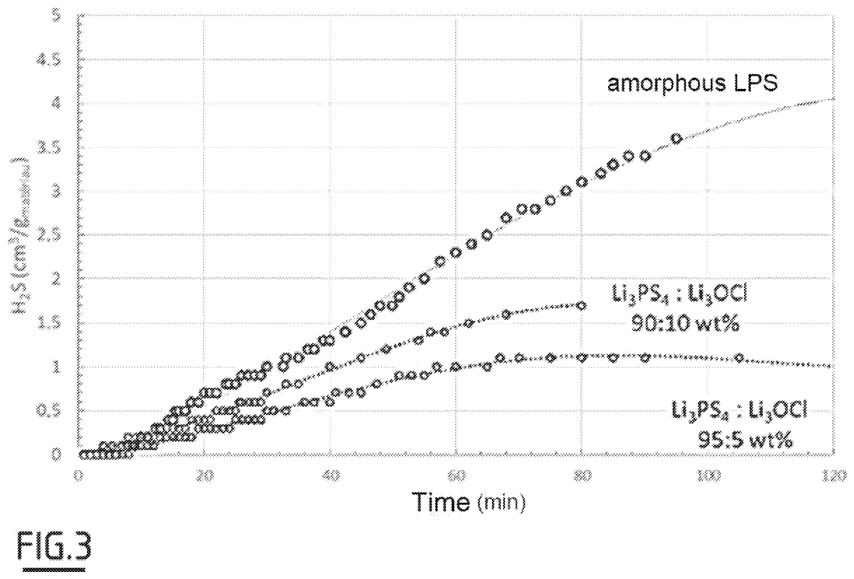

The DRXs of the other mixtures after 29 h of mechano-synthesis are shown in FIG. 1. Like for the compound with x=0.116, the compound with x=0.207 does not have any very significant peak. For the compounds Li₃(PS₄)_{0.616}(OCl)_{0.384} and Li₃(PS₄)_{0.286}(OCl)_{0.714}, the precursors are still clearly visible after the 29 h of mechano-synthesis (FIG. 3).

### Example 2: Release of H₂S

The release of hydrogen sulfide was measured for a mixed electrolyte according to the invention Li₃PS₄:Li₃OCl according to two compositions with x=0.116 and 0.207. The release was compared with the release from a sample of sulfide-alone electrolyte (amorphous LPS) with similar mass.

In order to measure the release of H₂S, 25 mg of powder were introduced at the initial time into a 2.5 l container which could be hermetically sealed and wherein an H₂S detector (accuracy of 1 ppm) was placed. In the present example, the container contained ambient air at atmospheric pressure and ambient temperature, so as to assess the risk associated with the release of H₂S under standard conditions in which the materials could be found. The H₂S concentration in the chamber was recorded at regular intervals as soon as the sample was introduced.

The results are shown in FIG. 3. The curves obtained show that the release from the compound with x=0.116 is lower than the release from the compound with x=0.207, further suggesting a synergistic effect for values of x less than 0.2.

### Example 3: Conductivity Measurement

Since the main function of the electrolyte is the conduction of ions, measurements of ionic conductivity were performed so as to verify the evolution thereof according to the compositions studied. For a given composition, powder coming from the synthesis was introduced into a cell similar to a pelletizing mold, the pistons of which were made of stainless steel and the body was made of insulating material. A pressure of 2t/cm² was maintained on the cell during the conductivity measurement. Such measurement was made by impedance (1 MHz to 200 mHz), at a plurality of temperature values from 20° C. to 60° C. The resistance value R from the measurement allowed us to calculate the conductivity value σ via the relation

$$σ = \frac{e}{R \cdot S} \qquad [ Maths 1 ]$$

The thickness e of the compressed pellet was measured with a micrometer (accuracy: 1 μm) and the surface area S was the surface area of the cell used.

The conductivity values obtained at 20 and 60° C. are given in Table 2.

TABLE 2

| | Surface | | Set-point | |
|---|---|---|---|---|
| Composition | area | Thickness | temperature | σ |
| Li₃(PS₄)₁₋ₓ(OCl)ₓ | (cm²) | (μm) | (° C.) | (MS/cm) |
| x = 0 | 0.385 | 600 | 20 | 0.16 |
| | | | 60 | 1.06 |
| x = 0.116 | 0.385 | 540 | 20 | 0.14 |
| | | | 60 | 0.87 |
| x = 0.207 | 0.385 | 480 | 20 | 0.16 |
| | | | 60 | 0.90 |

Such measurements show that the conductivity does not vary greatly from one sample to another, despite the decrease in the amount of sulfides.

The reduction in the quantity of H₂S released is thus not to the detriment of the capacity of the material to conduct lithium ions.

1. A compound with formula (I):
((A₍ₜ₋ᵥ₎B_{v/2})[(PS₄)₍₁₋ₓ₎(OH_{z}A_{U}X₁)ₓ])_{(1-y)}(LiₙX₂)_{y} (I)
Wherein:
A=Li,Na,K;
B=Mg,Ca;
X₁=F,Cl,Br,I;
X₂=N,O,S,F,Cl,Br,I,BH₄,CᵢBⱼHⱼ₊₁;
n is such that:
n=3 for X₂=N, or
n=2 for X₂=0,S, or
n=1 for X₂=F,Cl,Br,I,BH₄,CᵢBⱼHⱼ₊₁;
where i and j are integers and i=1 or 2 and 8≤j≤11;
0<y<0.40,
0<x<0.7,
0<z<1;
u is either positive, negative or zero, and such that u+z=0;
0≤v≤0.3;
2.8≤t≤3.5;
Where it is understood that X₂≠X₁.

2. The compound according to claim 1, such as in formula (I):
A=Li; and
X₁=Cl.

3. The compound according to claim 1 such as in formula (I):
Y=0;t=3,y=0,z=0 and u=0.

4. The compound according to am claim 1 wherein the compound with formula (I) is represented by formula (I′):
Li₃(PS₄)₁₋ₓ(OCl)ₓ (I′)
x being defined according to claim 1.

5. The compound according to claim 4, such that x is preferentially comprised between 0.02 and 0.20.

6. A preparation method for a compound of formula (I) as defined according to claim 1, such that same comprises the step of co-grinding crystalline precursors until an amorphous mixture is obtained.

7. An electrolyte for a battery comprising a compound with formula (I) as defined according to claim 1.

8. An electrochemical element comprising an electrolyte such as defined according to claim 7.

9. An electrochemical module comprising a stack of at least two elements according to claim 8, each element being electrically connected with one or a plurality of other elements.

10. A battery comprising one or a plurality of modules according to claim 9.
